(19) United States
(12) Patent Application Publication
(10) Pub. No.: US 2023/0222359 A1
(43) Pub. Date: Jul. 13, 2023

(54) CONVERSATIONAL ARTIFICIAL INTELLIGENCE SYSTEM WITH LIVE AGENT ENGAGEMENT BASED ON AUTOMATED FRUSTRATION LEVEL MONITORING

(71) Applicant: Dell Products L.P., Round Rock, TX (US)

(72) Inventors: Shibi Panikkar, Bangalore (IN); Thirumaleshwara Shama, Bangalore (IN); Jean Paul Sarkis, Austin, TX (US)

(21) Appl. No.: 17/572,844

(22) Filed: Jan. 11, 2022

(51) Int. Cl. G06N 5/02; H04L 51/02; G06F 40/216

(52) U.S. Cl. CPC G06N 5/022; H04L 51/02; G06F 40/216

(57) ABSTRACT

Conversational artificial intelligence techniques with live agent engagement based on automated frustration level monitoring are disclosed. For example, a method comprises obtaining, via a conversational artificial intelligence system, a frustration level metric associated with a user participating in a conversation with the conversational artificial intelligence system, The method further comprises managing, via the conversational artificial intelligence system, human agent engagement in the conversation based on the frustration level metric.

### FIELD

The field relates generally to information processing systems, and more particularly to conversational artificial intelligence systems in such information processing systems.

### DESCRIPTION

Artificial Intelligence (AI) applications such as conversational AI applications (also referred to as chatbots) are in widespread use. More and more organizations are adopting chatbots for supporting their customers in customer service and technical support. Chatbots are very effective with the standard frequently asked question (FAQ) type answers, as well as the computational and analytic type answers (e.g., revenue for this year, order backlog in a factory, etc.), and tend to perform better than humans in those scenarios. Customers though expect the chatbot to behave like a human by being able to ask complex questions and receive immediate answers. However, AI has not developed a level of contextual and emotional understanding of customers in order to answer such complex queries.

### SUMMARY

Illustrative embodiments provide conversational artificial intelligence techniques with live agent engagement based on automated frustration level monitoring in an information processing system.

For example, in an illustrative embodiment, a method comprises obtaining, via a conversational artificial intelligence system, a frustration level metric associated with a user participating in a conversation with the conversational artificial intelligence system, The method further comprises managing, via the conversational artificial intelligence system, human agent engagement in the conversation based on the frustration level metric.

In a further illustrative embodiment, obtaining the frustration level metric may further comprise utilizing a base frustration level metric as the frustration level metric at the start of the conversation, and utilizing a rate of increase parameter to adjust the base frustration level metric as the conversation progresses and use the adjusted frustration level metric as the frustration level metric.

In yet another illustrative embodiment, managing human agent engagement in the conversation based on the frustration level metric may further comprise monitoring where the frustration level metric falls within a set of frustration level ranges, wherein the conversational artificial intelligence system takes different actions based on within which one of the set of frustration level ranges that the frustration level metric falls.

These and other illustrative embodiments include, without limitation, apparatus, systems, methods and computer program products comprising processor-readable storage media.

### BRIEF DESCRIPTION OF THE DRAWINGS

FIG. 1 illustrates a conversational artificial intelligence system with which one or more illustrative embodiments can be implemented.

FIG. 2 illustrates a conversational artificial intelligence system with live agent engagement with which one or more illustrative embodiments can be implemented.

FIG. 3 illustrates a definition of an automated frustration measure model according to an illustrative embodiment.

FIG. 4 illustrates a conversation flow using an automated frustration measure model according to an illustrative embodiment.

FIG. 5 illustrates a conversational artificial intelligence system with live agent engagement based on automated frustration level monitoring according to an illustrative embodiment.

FIG. 6 illustrates further details of a frustration measure model according to an illustrative embodiment.

FIG. 7 illustrates further details of chat context building according to an illustrative embodiment.

FIG. 8 illustrates further details of agent handover management according to an illustrative embodiment.

FIGS. 9A and 9B illustrate further details of an agent manager according to an illustrative embodiment.

FIG. 10 illustrates an example of a processing platform that may be utilized to implement a conversational artificial intelligence system with live agent engagement based on automated frustration level monitoring functionalities according to an illustrative embodiment.

### DETAILED DESCRIPTION

With artificial intelligence (AI) technology becoming ubiquitous, the customer service and technical support industry expects smart machines to transform the customer experience. However, AI has not yet become the answer to all customer service/technical support challenges. The technology is moving forward at a rapid pace and is on path to achieve a level of impact previously predicted. AI and its enabling methodologies, e.g., machine learning (ML), deep learning (DL) and its applications such as natural language processing (NLP), computer vision and speech recognition, are the focus of major investments and research. Much progress has been made in processing and identifying incoming data. However, the challenge still lies in contextualizing and emotional derivation of this data, which is a fundamental requirement for human-like conversational skills. Systems such as Sofia, Alexa and Siri provide very useful AI-enabled conversational tools, however, none of them completely mimic human intelligence in a conversation. There is no exception to this drawback in AI-enabled chatbot (conversational AI) technology in the customer service and technical support area. A chatbot can answer most of the simple/analytical-based queries much faster than a human. However, in some cases, it is realized that chatbots can frustrate customers, especially in complex technical queries.

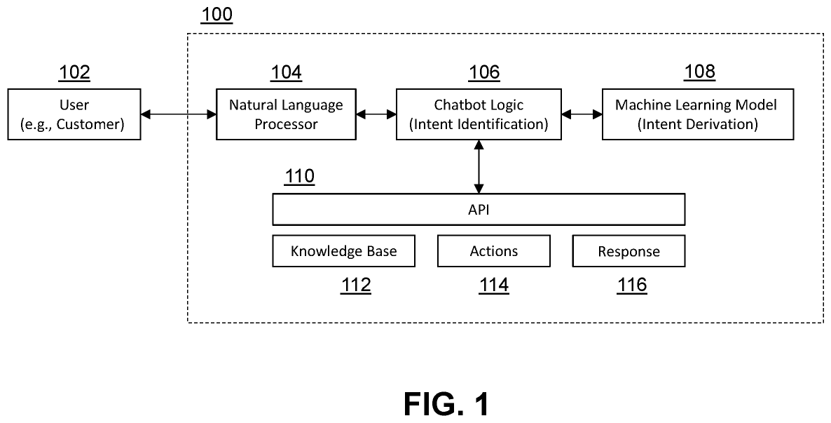

FIG. 1 illustrates a conversational AI system, i.e., a chatbot 100. As shown, a user 102 is operatively coupled to chatbot 100. Note that user 102, in one example, may represent a computing device of customer of an enterprise that deploys and maintains, or otherwise utilizes, chatbot 100 to provide automated technical support or other customer service to the customer. Further, chatbot 100 comprises a natural language processor 104 operatively coupled to chatbot logic 106, which is operatively coupled to a machine learning model 108. As further shown, chatbot logic 106 is operatively coupled, through an application programming interface (API) 110, to a knowledge base 112, an action store 114 and a response store 116.

In general, natural language processor 104 utilizes a natural language processing (NLP) algorithm to enable user 102 to communicate with chatbot 100 in a manner and language natural to user 102, e.g., processing a query from user 102 in a spoken language of the customer. Chatbot logic 106 provides intent identification based on an output of the NLP algorithm, while machine learning model 108 provides intent derivation. Based on knowledge programmed in knowledge base 112, a predetermined action from action store 114 and/or a predetermined response from response store 116 are returned to chatbot logic 106 and then initiated in response to the user query.

As mentioned above, the inability of chatbots, such as chatbot 100, to address complex queries from customers can lead, inter alia, to the loss of customers. So-called hybrid chatbot applications are taking the place of AI chatbot applications to attempt to address the shortcomings of the latter. In general, a hybrid chatbot has the speed of an AI chatbot but attempts to leverage the complex analytics of a human (e.g., a live agent).

Currently, in industry, a hybrid chatbot application in a service support platform engages a customer in conversation in one of the following ways. First, the customer may be given a selection option to communicate with a live agent. Second, a live agent may monitor multiple AI chatbots and intervene by taking over a conversation whenever appropriate. Lastly, the AI chatbot may hand over the conversation to a live agent when the AI chatbot cannot answer the customer query.

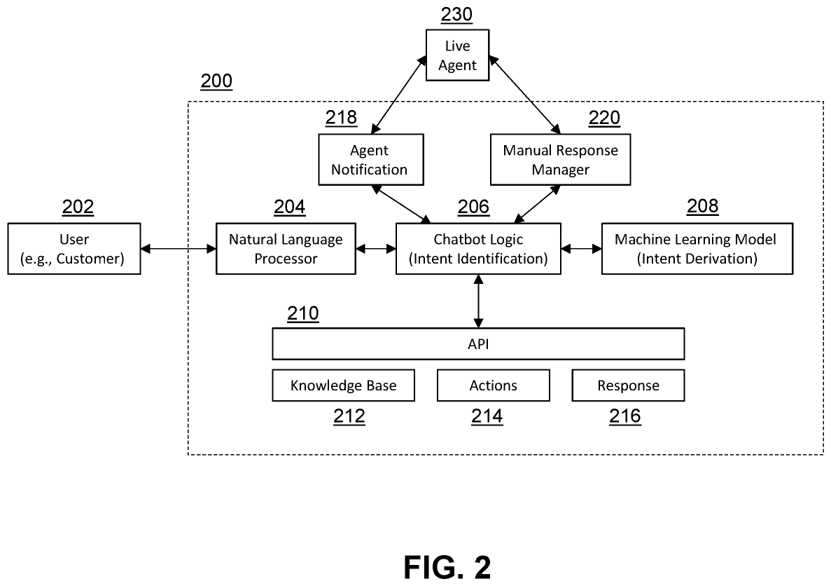

FIG. 2 illustrates a conversational AI system with live agent engagement, i.e., a hybrid chatbot 200. As shown, a user 202 is operatively coupled to hybrid chatbot 200. Note that user 202, in one example, may represent a computing device of customer of an enterprise that deploys and maintains, or otherwise utilizes, hybrid chatbot 200 to provide automated technical support or other customer service to the customer. Further, hybrid chatbot 200 comprises a natural language processor 204 operatively coupled to chatbot logic 206, which is operatively coupled to a machine learning model 208. As further shown, chatbot logic 206 is operatively coupled, through an application programming interface (API) 210, to a knowledge base 212, an action store 214 and a response store 216. Note that the above-mentioned components shown in FIG. 2 labeled 202 through 216 have similar or the same functionalities as the similarly named components in FIG. 1 labeled 102 through 116 with any exceptions to be explained below.

In addition, hybrid chatbot 200 also comprises an agent notification module 218 and a manual response manager 220 operatively coupled to chatbot logic 206. Agent notification module 218 and manual response manager 220 are operatively coupled to a live agent 230. Note that live agent 230, in one example, may represent a computing device of a technical support or other customer service person associated with an enterprise that deploys and maintains, or otherwise utilizes, hybrid chatbot 200 to provide automated technical support or other customer service to user 202.

In general, in accordance with hybrid chatbot 200, agent notification module 218 generates a notification to live agent 230 from chatbot logic 206 regarding the conversation with user 202. Manual response manager 220 receives input from live agent 230 and conveys the live agent response to chatbot logic 206.

More particularly, when the hybrid chatbot 200 cannot resolve intent of user 202 (e.g., when chatbot logic 206 answers “I don't understand your question”), hybrid chatbot 200 sends all chat details to live agent 230. Live agent 230 reads the previous chat and takes up the customer conversation from there. In another scenario, live agent 230 can monitor different chatbot conversations. When live agent 230 sees that hybrid chatbot 200 is failing to address user 202 adequately, live agent 230 can take over the conversation. Still further, hybrid chatbot 200 can give an option to user 202 to talk to a live agent at any point of the conversation.

Many technical problems arise from these existing hybrid chatbot, e.g., hybrid chatbot 200, approaches. For example, when a customer chooses to speak to a live agent and diverts from the hybrid chatbot, an appropriate agent may be assisting other customers and thus may not be available. Also, at the time a hybrid chatbot hands the conversation over to the live agent, the agent may be reading the full chat history to understand the context of the customer issue, and thus not be immediately available. Then, once the live agent joins the conversation, the agent may need to start the conversation from scratch. Though this hybrid approach helps the industry, it is realized herein that there are many technical shortcomings which can frustrate the customer and even lead to the loss of customers.

While live agent engagement is a benefit to AI-based conversational systems, it is realized herein that the timing of when a live agent is engaged by a hybrid chatbot can have an impact on the user experience. Since the hybrid chatbot typically keeps the conversation with the customer until it cannot resolve intent of the customer, the hybrid chatbot sends the chat details to the live agent perhaps too late. Different customers react in different ways. Asking too many questions to the customer can build up a frustration level for the customer, and a conventional hybrid chatbot does not have the capability to understand the measure of frustration for each customer. The live agent takes time to understand the context of the conversation by reading the entire chat or may be engaged with other customers, and thus may not be available to attend at the time when the hybrid chatbot fails to reply. It is realized herein that such delay can add to the frustration of the customer. Also, while a live agent monitors chatbot conversations and intervenes wherever necessary, this approach works only if a limited number of customers are assigned to one live agent. If there are too many customers assigned to one live agent, it is not feasible for the live agent to read all the chats.

In short, conventional hybrid chatbot models do not to engage the live agent (human) efficiently due to a lack of knowledge of when to engage (i.e., different customers in different times, etc.) and how to engage (i.e., real-time help, asynchronous engagement, immediate engagement, etc.).

Illustrative embodiments overcome the above and other technical problems with conventional hybrid chatbots by providing live agent engagement based on automated frustration level monitoring according to an illustrative embodiment. More particularly, one or more illustrative embodiments provide an automated frustration measure model that is used, inter alia, to improve the timing and method of live agent engagement.

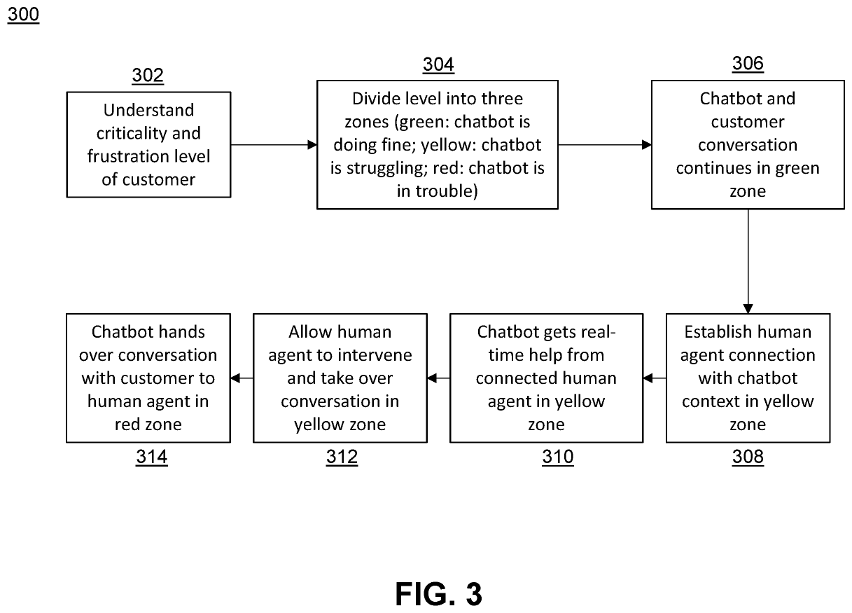

By way of example, FIG. 3 illustrates a definition of an automated frustration measure model 300 according to an illustrative embodiment. As shown, an automated frustration measure model 300 is configured to provide the following frustration level monitoring functionalities:

Step 302: Understand the criticality and frustration level of a customer and act accordingly;

Step 304: Divide the frustration level into multiple zones (i.e., frustration level ranges), e.g., three zones such as green indicating that the hybrid chatbot is doing fine with respect to the current customer (no customer frustration level to moderate customer frustration level detected but below a high customer frustration level threshold); yellow indicating that the hybrid chatbot is struggling with respect to the current customer (at or above the high customer frustration level threshold but below a critical customer frustration level threshold); and red indicating that the hybrid chatbot is having trouble with respect to the current customer (at or above the critical customer frustration level threshold). Note that the number of zones (ranges) may vary in alternative embodiments.

Step 306: When the customer frustration level is detected to be in the green zone, the hybrid chatbot and customer conversation continues without live agent engagement.

Step 308: When the customer frustration level is detected to be in the yellow zone, a connection between the hybrid chatbot and a live agent is established.

Step 310: Further to step 308, when the customer frustration level is detected to be in the yellow zone, the hybrid chatbot gets real-time help from the connected live agent.

Step 312: Further to step 310, when the customer frustration level is detected to be in the yellow zone, the hybrid chatbot allows the connected live agent to take over the conversation with the customer.

Step 314: When the customer frustration level is detected to be in the red zone, the hybrid chatbot hands over the conversation with the customer to the connected live agent.

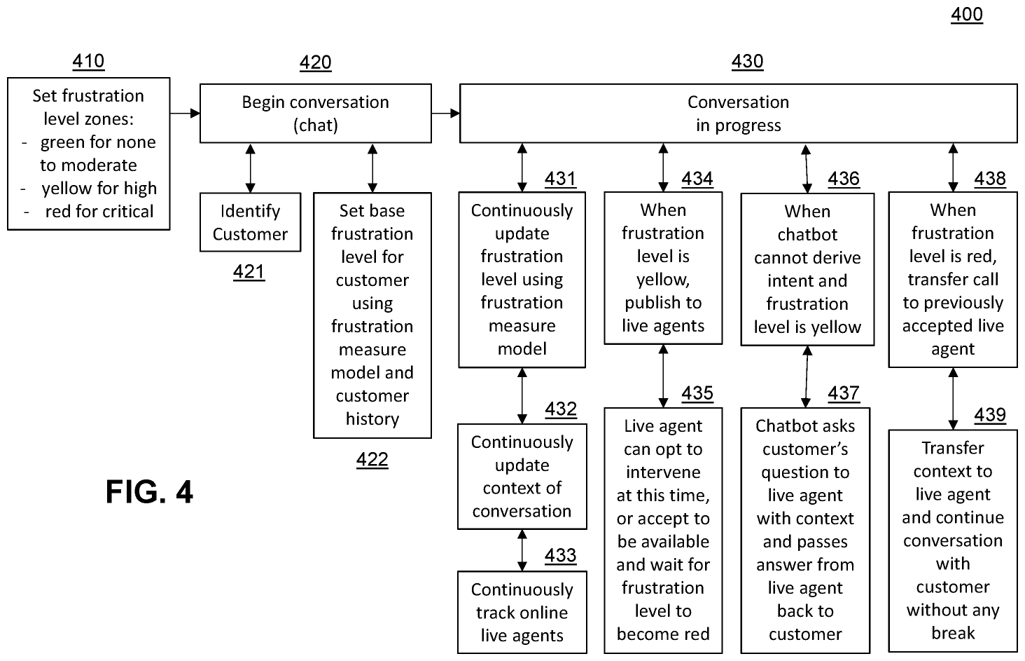

Turning now to FIG. 4, an exemplary conversation flow 400 using an automated frustration measure model according to an illustrative embodiment is depicted. As shown in block 410, the frustration level zones are defined as depicted in FIG. 3, i.e., green zone when no or moderate customer frustration level is detected, yellow zone when high customer frustration level is detected, and red zone when critical customer frustration level is detected.

Block 420 denotes the beginning of a conversation between the hybrid chatbot and a customer. In step 421, the customer type is identified. By way of example only, assuming an enterprise such as an original equipment manufacturer (OEM) is deploying the hybrid chatbot, the customer can be identified as an enterprise customer, a commercial customer, or an end customer.

Of course, these are just examples of customer or user types and not intended to limit any embodiments described herein.

Assume that, in a non-limiting example, the frustration level is metered from 0 to 10. Then, the threshold (boundaries) for the frustration levels can be set, by way of example only, at 7 as high (yellow) and 10 as critical (red). So, there are three zones where the hybrid chatbot and customer interact: green zone (frustration level 0-6); yellow zone (frustration level 7-9); and red zone (frustration level 10 and above).

In step 422, based on the customer who logged in, the base frustration level is set based on the identified customer type. By way of example only, base frustration levels may be set based on customer type as follows: for an enterprise customer, set the base frustration level to 6; for a commercial customer, set the base frustration level to 4; for an end customer, set the base frustration level to 0; and for an enterprise customer with a previous history (customer history) of frustration using the hybrid chatbot, set the base frustration level to 7 (start in the yellow zone). The zones and settings are considered part of a frustration measure model.

Following these frustration measure model initialization steps, block 430 denotes the conversation is in progress between the hybrid chatbot and the current identified customer.

Step 431 continuously updates the frustration level (beginning from the base frustration level) of the current customer using the frustration measure model. Step 432 continuously updates the context of the conversation. Step 433 continuously tracks online live agents. Note that the rate of increase of the frustration level can be based on a number of factors. For example, in one illustrative embodiment, the factors can include: (i) criticality of the conversation (e.g., if it is considered a high value customer), then the rate of increase per conversation will be higher, while if the conversation is simply FAQs, the rate of increase will be lower or even zero); (ii) number of lines of chats; (iii) active time spent; (iv) intent derivation (e.g., simple, medium, complex, not derived); and (v) finite answer (e.g., set back the frustration level back to base frustration level). The rate of increase of the frustration level will be further explained below.

Assume that the frustration level as measured by the frustration measure model is in the yellow zone. Step 434 publishes the conversation context to the live agents. In step 435, a live agent can opt to intervene, or accept the responsibility of monitoring this particular chat and be available should the frustration level go into the red zone.

Assume, as per step 436, that the hybrid chatbot cannot derive intent and the frustration level as measured by the frustration measure model is in the yellow zone. Then, in step 437, the hybrid chatbot can ask the customer's question to a live agent with context and pass the answer from the live agent back to customer.

Assume the frustration level as measured by the frustration measure model is in the red zone. Step 438 then transfers the call to the previously accepted live agent (from step 435) and step 439 transfers the context to the live agent and continues the conversation with the customer without any interruption to the customer.

It is to be appreciated that the above definitions of frustration level zones and base frustration levels, as well as actions to be triggered based on the definitions, can be dynamically adjusted based on the conversational environment in which the hybrid chatbot is or will be deployed.

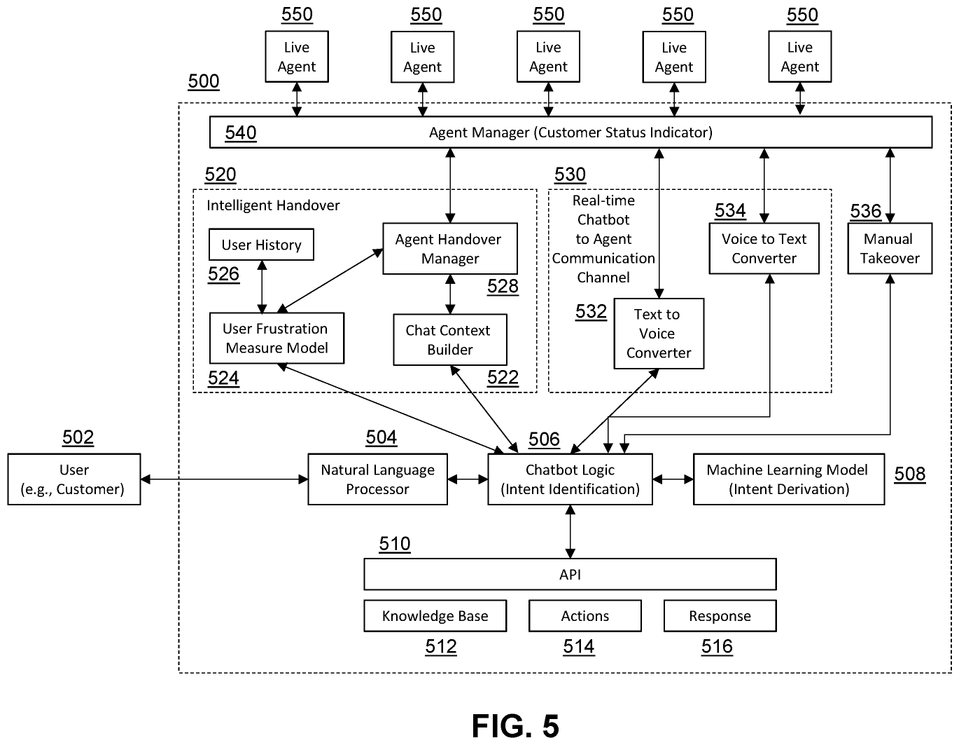

FIG. 5 illustrates a conversational artificial intelligence system with live agent engagement based on automated frustration level monitoring according to an illustrative embodiment. More particularly, conversational artificial intelligence system of FIG. 5 can be used to implement automated frustration measure model 300 of FIG. 3 and conversation flow 400 of FIG. 4, as well as alternative definitions and/or conversation flows.

As shown, a user 502 is operatively coupled to a hybrid chatbot 500. Note that user 502, in one example, may represent a computing device of customer of an enterprise that deploys and maintains, or otherwise utilizes, hybrid chatbot 500 to provide automated technical support or other customer service to the customer. Further, hybrid chatbot 500 comprises a natural language processor 504 operatively coupled to chatbot logic 506, which is operatively coupled to a machine learning model 508. As further shown, chatbot logic 506 is operatively coupled, through an application programming interface (API) 510, to a knowledge base 512, an action store 514 and a response store 516. Note that the above-mentioned components shown in FIG. 5 labeled 502 through 516 have similar or the same functionalities as the similarly named components in FIG. 2 labeled 202 through 216 with some main differences to be explained below.

In addition, hybrid chatbot 500 also comprises an intelligent handover subsystem 520 comprising a chat context builder 522, a user frustration measure model 524, a user history store 526, and an agent handover manager 528. Hybrid chatbot 500 further comprises a real-time chatbot to agent communication channel 530 comprising a text to voice converter 532 and a voice to text converter 534. Hybrid chatbot 500 also comprises a manual takeover module 536 and an agent manager 540 (with customer status indicator as will be further explained below). Agent manager 540 is operatively coupled to a plurality of live agents 550 (collectively referred to herein as live agents 550 and individually as live agent 550). Note that each live agent 550, in one example, may represent a computing device of a technical support or other customer service person associated with an enterprise that deploys and maintains, or otherwise utilizes, hybrid chatbot 500 to provide automated technical support or other customer service to user 502.

As will be explained in further detail, agent handover manager 528 is configured to understand user 502, understand the frustration level of user 502, serve as an online live agent tracker, and serve as a processor of a context built by chat context builder 522. Real-time chatbot to agent communication channel 530 is configured to provide for real-time chatbot to live agent sub-communication during the chatbot to user conversation. Text to voice converter 532 converts text from the hybrid chatbot 500 to voice for the live agent 550, and voice to text converter 534 converts voice from live agent 550 to text for hybrid chatbot 500. Manual takeover module 536 enables any live agent 550 to override the automated live agent engagement functionalities of hybrid chatbot 500 to take control of the conversation with user 502. Agent manager 540 provides visibility of the frustration level of user 502 in real time during the conversation between hybrid chatbot 500 and user 502, as well as the ability for any live agent 550 to intervene when warranted (e.g., when the frustration level is yellow or above).

As mentioned above, intelligent handover subsystem 520 comprises chat context builder 522, user frustration measure model 524, user history store 526, and agent handover manager 528. Further details of these modules will now be explained.

User frustration measure model 524 may be considered a frustration meter and thus measures the frustration level of the customer when the conversation between hybrid chatbot 500 and user 502 occurs. As explained above, user frustration measure model 524 is configured to allow a base frustration level to be set for different customer types (based on user history with hybrid chatbot 500 from user history store 526), and the frustration level to be divided into multiple zones or ranges, e.g., recall green zone (hybrid chatbot doing well), yellow zone (hybrid chatbot is struggling), and red zone (hybrid chatbot immediately cedes control of the chat to a live agent) as explained above.

Chat context builder 522 prepares a summarized (short) context of the chat that live agent 550 can easily go through and understand the context of the chat. This summarized context, which is a condensed version or summary of the complete chat, enables live agent 550 to gain an understanding of the conversation quickly rather than having to read through the entire chat.

Agent handover manager 528 broadcasts the frustration level to agent manager 540 when the frustration level changes from the green zone to the yellow zone. When the frustration level changes to the red zone, agent handover manager 528 initiates the process of handing over the conversation to live agent 550. Also, this will result in resetting the frustration level to the base frustration level when the finite answer is given to the customer queries by user 502 or when manual customer feedback is positive.

Advantageously, user frustration measure model 524 is the main module to set the base frustration level for the customer type, and to generate and maintain the varying frustration level of the customer throughout the conversation. User frustration measure model 524 not only measures the customer's frustration level, but also weighs the importance of the customer in conjunction with the customer's intent.

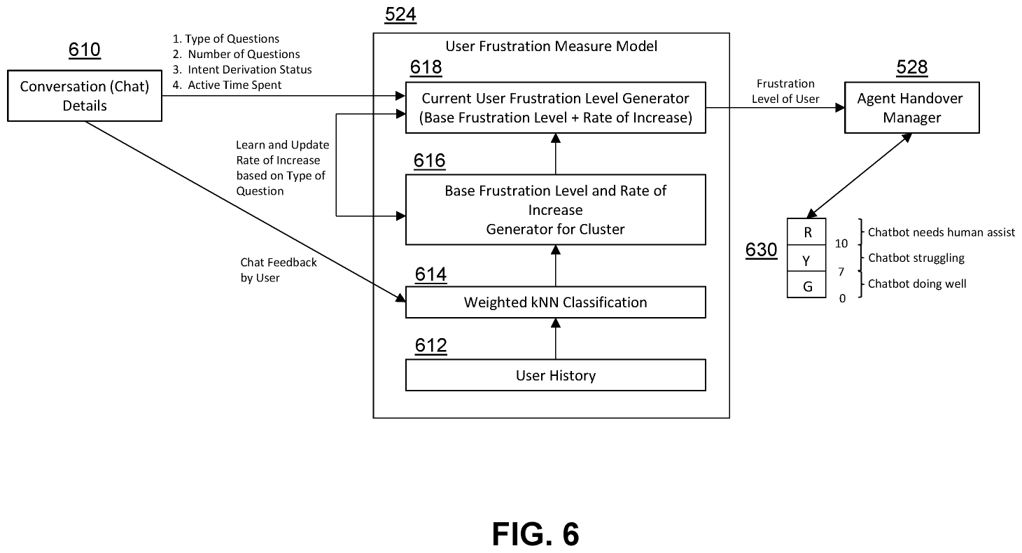

FIG. 6 illustrates further details of use frustration measure model 524 from FIG. 5. As shown, conversation (chat) details 610 provide input data for user frustration measure model 524 including data indicative of, by way of example, the type of questions user 502 is asking hybrid chatbot 500, the number of questions user 502 is asking hybrid chatbot 500, an intent derivation status from machine learning model 508, and the active time spent by hybrid chatbot 500 in conversation with user 502. Additionally, conversation details 610 can include chat feedback from user 502.

As further shown, user frustration measure model 524 comprises user history data 612 (from user history store 526, a weighted kNN classification module 614 which implements a k-nearest neighbors algorithm for classification, a base frustration level and rate of increase generator 616 for clusters of users, and a current user frustration level generator 618.

By way of example only, assume user 502 is an enterprise customer of the OEM that implements or otherwise utilizes hybrid chatbot 500. If the conversation is about a complicated and perhaps expensive product, the OEM likely wants to minimize the chatbot to user conversation length. Assume, as shown, a frustration zone partition 630 is metered from 0 to 10, as described above in accordance with FIG. 4, with three zones including a green (G) zone with frustration level range 0-6, a yellow (Y) zone with frustration level range 7-9, and a red (R) zone with frustration level range 10 and above.

If the enterprise customer (user 502) starts the conversation with hybrid chatbot 500 with a base frustration level in the yellow zone (e.g., 8), hybrid chatbot 500 can start the handover process immediately. Moreover, the frustration level will increase faster (due to a higher preset rate of increase for this type of user) as the conversation continues. Likewise, if the enterprise customer is a user who already had a difficult chatbot experience or the OEM in general, the OEM likely will want to minimize the time the user is engaged with the chatbot and thus get the user to a live agent more quickly. This is accomplished by assigning a faster rate of increase to the frustration level for this user type, as explained herein. If, however, the user is asking the questions for which intent is derived quickly (e.g., FAQ or analytics type questions), hybrid chatbot 500 is doing a good job, so the frustration level will rise more slower or not at all.

In illustrative embodiments, setting of the base frustration level and rate of increase depends on conversation details 610 and user history data 612, as will now be further explained. User frustration measure model 524 obtains user history data 612 and utilizes weighted kNN classification module 614 to classify users into clusters, for example, as critical, high, medium, and low using a weighted k-nearest neighbors algorithm with factors such as, but not limited to, types of customers (e.g., enterprise, partner, commercial, end customer), chat feedback (e.g., excellent, good, bad), and customer satisfaction (CSAT) scores. For example, resulting classifications can include:

Enterprise, Partner, Commercial+Bad Chat Feedback→Critical

Enterprise+Good Chat Feedback→Critical

Partner, Commercial+Good Chat Feedback→High

End Customer+Bad Chat feedback→Medium

End Customer+Excellent Chat feedback→Low

Then, base frustration level and rate of increase generator 616 generates the optimal base frustration level for each classification. The level can start with a value based on experience and then be adjusted based on further experience feedback. The rate of increase (which, in one example, can be defined as the percentage increase of the frustration level from the base) generated by base frustration level and rate of increase generator 616 depends of the classified clusters. The critical cluster has the highest rate of increase, while the low cluster has the lowest. This is set starting with experience and updated with learning initially. The rate of increase also depends on the type of questions asked. The adjustments are made at the runtime (e.g., at the time of conversation) and can be applied in current user frustration level generator 618. For example, if the customer is asking about a high value product, the rate of increase of the frustration level is increased (and the customer will progress to speaking with a live agent sooner), while for a customer asking an FAQ, the rate of increase is reduce or is zero (and the customer will remain speaking with the hybrid chatbot longer).

By way of example, when hybrid chatbot 500 starts the conversation with user 502:

Current Frustration Level=Base Frustration Level

For each question asked or time spent in chat:

Current Frustration Level=Current Frustration Level+(Current Frustration Level*Rate of Increase).

Current Frustration Level is re-calculated on each question and response. When hybrid chatbot 500 derives the intent correctly, then Current Frustration Level is not changed or a small rise is applied based on the number of questions already asked in that context.

Note that, as illustratively used herein, the term frustration level and like terms (e.g., Current Frustration Level) can more generally be referred to as a frustration level metric, such that the initial frustration level metric (e.g., Base Frustration Level) can more generally be referred to as a base frustration level metric. Further, as illustratively used herein, the term rate of increase and like terms (e.g., Rate of Increase) can more generally be referred to as a rate of increase parameter.

Further, as shown, the frustration level of the user is published from user frustration measure model 524 to agent handover manager 528 to initiate live agent engagement in accordance with frustration zone partition 630 as described above. Chat customer feedback is fed back to weighted kNN classification module 614 and customers are re-classified based on the new learning. Thus, one or more embodiments of user frustration measure model 524 are implemented using machine learning.

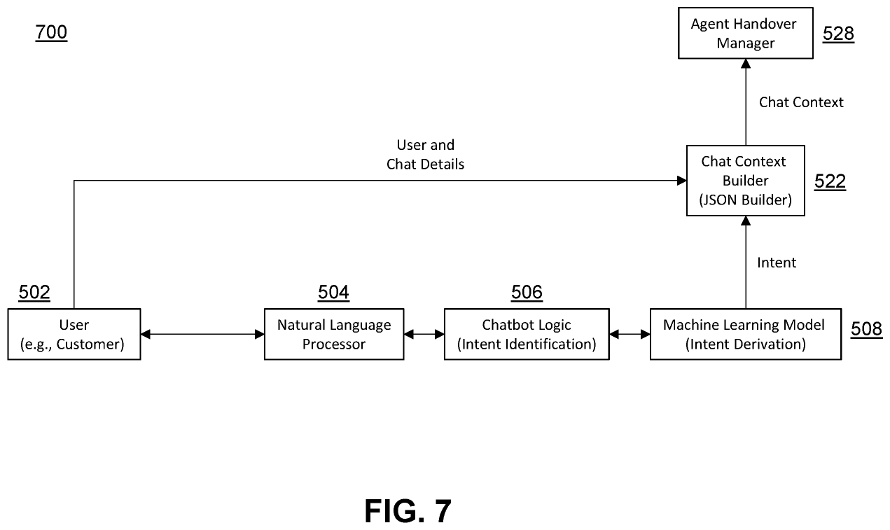

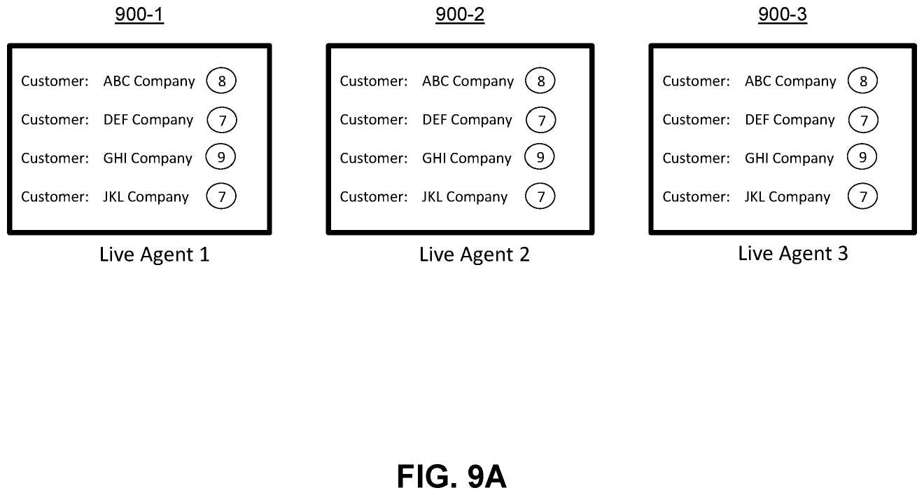

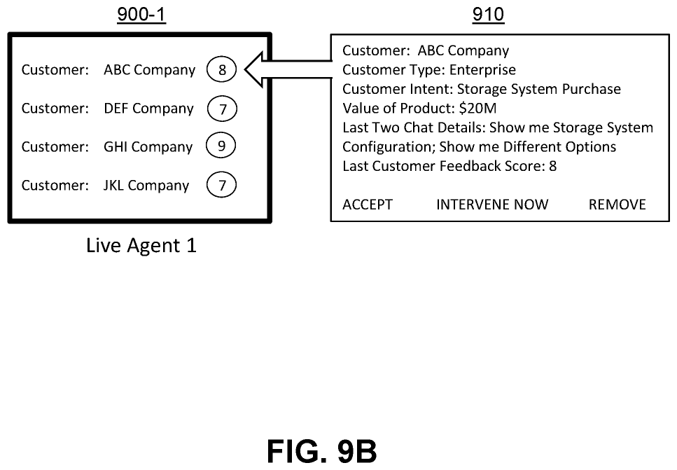

Referring now to FIG. 7, further details of chat context building are described in accordance with relevant portions 700 of hybrid chatbot 500. As shown, for each conversation, chat context builder 522 obtains user and chat details and constructs a chat context which contains a summary context (an example of which is illustrated in and will be described below in accordance with FIG. 9B) which includes customer identity, customer type, customer intent, value of product, last two chat details, and last customer feedback score. The chat context, in some embodiments, may be a file in a JavaScript Object Notation (JSON) format. The JSON file is sent to agent handover manager 528 along with the frustration level from user frustration measure model 524 (FIG. 6) so that agent handover manager 528 can manage live agent engagement as described herein.

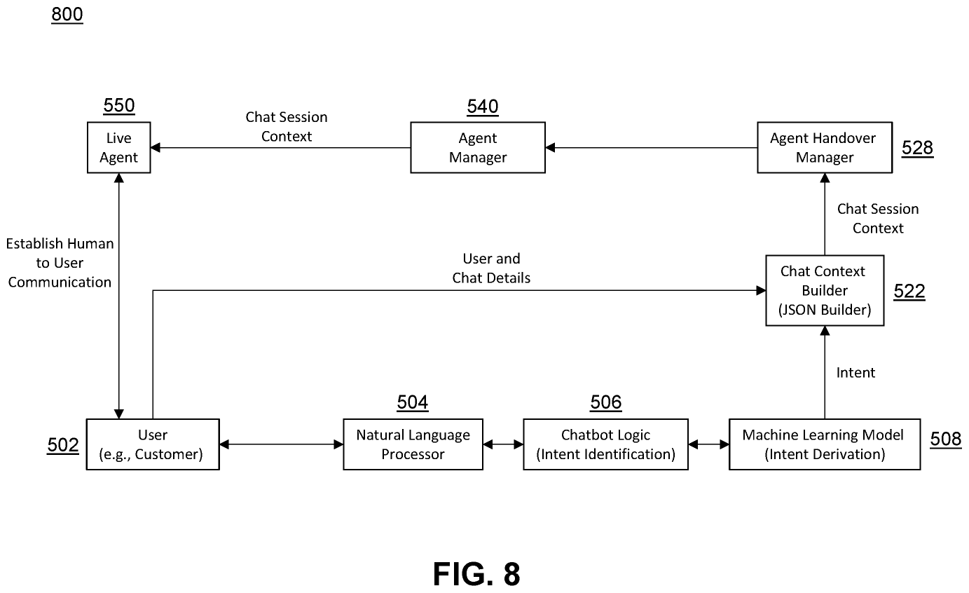

FIG. 8 shows further details of agent handover management in accordance with relevant portions 800 of hybrid chatbot 500. Agent handover manager 528 is fed the JSON file from chat context builder 522 and the frustration level from user frustration measure model 524 (FIG. 6). When the frustration level falls into the yellow zone, agent handover manager 528 consolidates the frustration level, customer details and chat context (JSON file) and sends the data to agent manager 540 which then provides live agent 550 with the chat context. When the frustration level falls into the red zone, agent manager 540 connects live agent 550 into the conversation, and live agent 550 takes over the chat from hybrid chatbot 500.

FIGS. 9A and 9B illustrate examples of graphical user interfaces and chat contexts (e.g., JSON file) presented to a live agent by agent manager 540 which manages live agents 550. Once agent manager 540 receives a trigger message from agent handover manager 528 (e.g., when the frustration level is in the yellow zone), the same is broadcasted to all live agents 550. FIG. 9A shows user interfaces 900-1, 900-2, and 900-3 that agent manager 540 respectively presents to Live Agent 1, Live Agent 2 and Live Agent 3. A status circle next to each customer name indicates the current frustration level for that user. Thus, for example, each live agent is given the same information indicating the current frustration level for each customer currently participating in a chat with hybrid chatbot 500. For example, as shown, callers from each of the four companies (ABC Company, DEF Company, GHI Company, and JKL Company) all have frustration levels currently in the yellow zone (between 7-9).

As shown in FIG. 9B, each live agent (e.g., Live Agent 1 here) can view the chat context in a pop-up feature 910 for one of the chats by clicking on the status circle in user interface 900-1 for that customer. Pop-up feature 910 also includes three selectable buttons that the live agent can select (by clicking on): Accept, Intervene Now, and Remove.

Upon selection of Accept, the connection between the hybrid chatbot the live agent is established. Then when the hybrid chatbot hands over the chat (e.g., frustration level goes into the red zone), the handover process is seamless. There is no need to wait for any live agent to come online or establish the connection. In this scenario, the hybrid chatbot performs real-time streaming of data to the live agent to get complex questions answered in real-time. Further, upon selection of Intervene Now, the live agent takes over the chat from there using a manual handover module (536 in FIG. 5). Still further, upon selection of Remove, the pop-up feature 910 is deleted from that live agent's user interface.

Thus, in accordance with pop-up feature 910, when the frustration level is in the yellow zone, one of the live agents can either accept the broadcast or take over. On accept, the hybrid chatbot and live agent connection is established such that, when the customer asks any complex query for which the hybrid chatbot cannot resolve intent, real-time communication between the hybrid chatbot and the live agent occurs (e.g., via real-time chatbot to agent communication channel 530 in FIG. 5). More particularly, the customer's query is converted into voice and streamed to the live agent through the pre-established connection (upon selection of Accept). The live agent can hear the customer query and reply in voice, which is converted to text and streamed to the hybrid chatbot which can then respond intelligently to the customer's question.

Advantageously, a hybrid chatbot approach according to illustrative embodiments enables customer support using a well-balanced mix of human and chatbot engagement. As described in detail herein, such advantages are provided by systems and methods to measure the criticality and frustration level in a hybrid chatbot model during the chatbot-customer conversation. Illustrative embodiments utilize machine language-based customer classification and customer type scoring for deriving and suggesting a base frustration level to start the chatbot-customer conversation. Further, illustrative embodiments classify the customer criticality and frustration level in different zones, e.g., green (all good), yellow (chatbot struggles), and red (chatbot initiates handover to a human agent). Illustrative embodiments also provide for the hybrid chatbot to take real-time help from a human agent when it cannot derive intent in the yellow zone. In sum, illustrative embodiments overcome technical problems associated with conventional chatbot approaches by providing technical solutions including an efficient and balanced human/chatbot model using conversational AI.

Illustrative embodiments are described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Cloud infrastructure can include private clouds, public clouds, and/or combinations of private/public clouds (hybrid clouds).

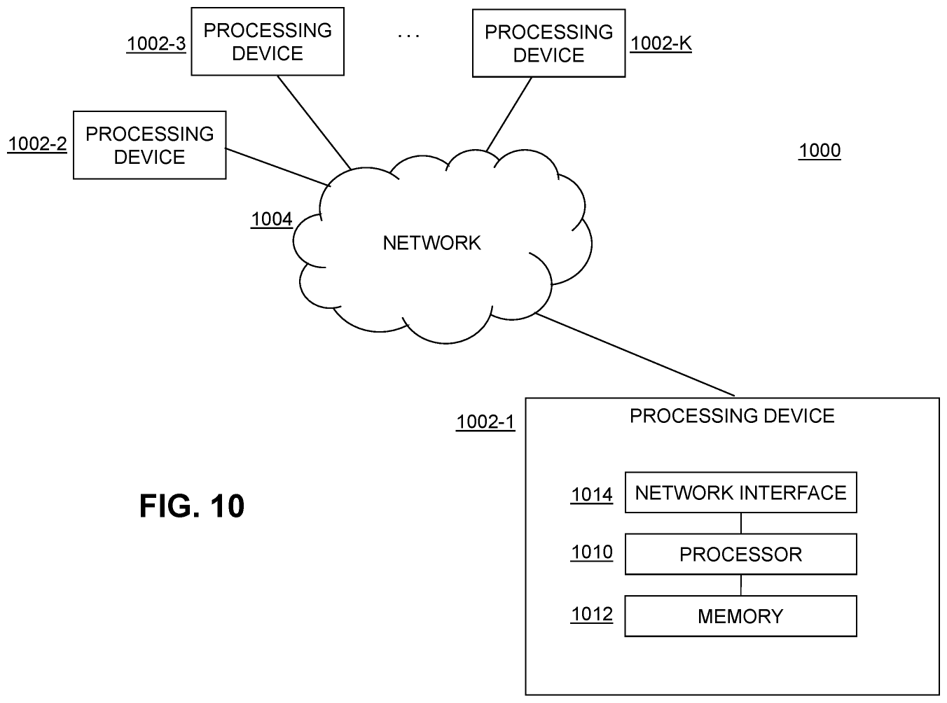

FIG. 10 depicts a processing platform 1000 used to implement information processing systems/processes depicted in FIGS. 1 through 9B, respectively, according to an illustrative embodiment. More particularly, processing platform 1000 is a processing platform on which a computing environment with functionalities described herein can be implemented.

The processing platform 1000 in this embodiment comprises a plurality of processing devices, denoted 1002-1, 1002-2, 1002-3, . . . 1002-K, which communicate with one another over network(s) 1004. It is to be appreciated that the methodologies described herein may be executed in one such processing device 1002, or executed in a distributed manner across two or more such processing devices 1002. It is to be further appreciated that a server, a client device, a computing device or any other processing platform element may be viewed as an example of what is more generally referred to herein as a “processing device.” As illustrated in FIG. 10, such a device generally comprises at least one processor and an associated memory, and implements one or more functional modules for instantiating and/or controlling features of systems and methodologies described herein. Multiple elements or modules may be implemented by a single processing device in a given embodiment. Note that components described in the architectures depicted in the figures can comprise one or more of such processing devices 1002 shown in FIG. 10. The network(s) 1004 represent one or more communications networks that enable components to communicate and to transfer data therebetween, as well as to perform other functionalities described herein.

The processing device 1002-1 in the processing platform 1000 comprises a processor 1010 coupled to a memory 1012. The processor 1010 may comprise a microprocessor, a microcontroller, an application-specific integrated circuit (ASIC), a field programmable gate array (FPGA) or other type of processing circuitry, as well as portions or combinations of such circuitry elements. Components of systems as disclosed herein can be implemented at least in part in the form of one or more software programs stored in memory and executed by a processor of a processing device such as processor 1010. Memory 1012 (or other storage device) having such program code embodied therein is an example of what is more generally referred to herein as a processor-readable storage medium. Articles of manufacture comprising such computer-readable or processor-readable storage media are considered embodiments of the invention. A given such article of manufacture may comprise, for example, a storage device such as a storage disk, a storage array or an integrated circuit containing memory. The term “article of manufacture” as used herein should be understood to exclude transitory, propagating signals.

Furthermore, memory 1012 may comprise electronic memory such as random-access memory (RAM), read-only memory (ROM) or other types of memory, in any combination. The one or more software programs when executed by a processing device such as the processing device 1002-1 causes the device to perform functions associated with one or more of the components/steps of system/methodologies in FIGS. 1 through 9B. One skilled in the art would be readily able to implement such software given the teachings provided herein. Other examples of processor-readable storage media embodying embodiments of the invention may include, for example, optical or magnetic disks.

Processing device 1002-1 also includes network interface circuitry 1014, which is used to interface the device with the networks 1004 and other system components. Such circuitry may comprise conventional transceivers of a type well known in the art.

The other processing devices 1002 (1002-2, 1002-3, . . . 1002-K) of the processing platform 1000 are assumed to be configured in a manner similar to that shown for computing device 1002-1 in the figure.

The processing platform 1000 shown in FIG. 10 may comprise additional known components such as batch processing systems, parallel processing systems, physical machines, virtual machines, virtual switches, storage volumes, etc. Again, the particular processing platform shown in this figure is presented by way of example only, and the system shown as 1000 in FIG. 10 may include additional or alternative processing platforms, as well as numerous distinct processing platforms in any combination.

Also, numerous other arrangements of servers, clients, computers, storage devices or other components are possible in processing platform 1000. Such components can communicate with other elements of the processing platform 1000 over any type of network, such as a wide area network (WAN), a local area network (LAN), a satellite network, a telephone or cable network, or various portions or combinations of these and other types of networks.

Furthermore, it is to be appreciated that the processing platform 1000 of FIG. 10 can comprise virtual (logical) processing elements implemented using a hypervisor. A hypervisor is an example of what is more generally referred to herein as “virtualization infrastructure.” The hypervisor runs on physical infrastructure. As such, the techniques illustratively described herein can be provided in accordance with one or more cloud services. The cloud services thus run on respective ones of the virtual machines under the control of the hypervisor. Processing platform 1000 may also include multiple hypervisors, each running on its own physical infrastructure. Portions of that physical infrastructure might be virtualized.

As is known, virtual machines are logical processing elements that may be instantiated on one or more physical processing elements (e.g., servers, computers, processing devices). That is, a “virtual machine” generally refers to a software implementation of a machine (i.e., a computer) that executes programs like a physical machine. Thus, different virtual machines can run different operating systems and multiple applications on the same physical computer. Virtualization is implemented by the hypervisor which is directly inserted on top of the computer hardware in order to allocate hardware resources of the physical computer dynamically and transparently. The hypervisor affords the ability for multiple operating systems to run concurrently on a single physical computer and share hardware resources with each other.

It was noted above that portions of the computing environment may be implemented using one or more processing platforms. A given such processing platform comprises at least one processing device comprising a processor coupled to a memory, and the processing device may be implemented at least in part utilizing one or more virtual machines, containers or other virtualization infrastructure. By way of example, such containers may be Docker containers or other types of containers.

The particular processing operations and other system functionality described in conjunction with FIGS. 1-10 are presented by way of illustrative example only, and should not be construed as limiting the scope of the disclosure in any way. Alternative embodiments can use other types of operations and protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the above-described embodiments of the invention are presented for purposes of illustration only. Many variations may be made in the particular arrangements shown. For example, although described in the context of particular system and device configurations, the techniques are applicable to a wide variety of other types of data processing systems, processing devices and distributed virtual infrastructure arrangements. In addition, any simplifying assumptions made above in the course of describing the illustrative embodiments should also be viewed as exemplary rather than as requirements or limitations of the invention.

What is claimed is:

1. An apparatus comprising:
at least one processing device comprising a processor coupled to a memory, the at least one processing device, when executing program code, operates as a conversational artificial intelligence system configured to:
obtain a frustration level metric associated with a user participating in a conversation with the conversational artificial intelligence system; and
manage human agent engagement in the conversation based on the frustration level metric.

2. The apparatus of claim 1, wherein obtaining the frustration level metric further comprises utilizing a base frustration level metric as the frustration level metric at the start of the conversation.

3. The apparatus of claim 2, wherein obtaining the frustration level metric further comprises utilizing a rate of increase parameter to adjust the base frustration level metric as the conversation progresses and use the adjusted frustration level metric as the frustration level metric.

4. The apparatus of claim 3, wherein the conversational artificial intelligence system is further configured to precompute the base frustration level metric and rate of increase parameter utilizing a machine learning-based classification algorithm.

5. The apparatus of claim 4, wherein precomputing the base frustration level metric and the rate of increase parameter utilizing a machine learning-based classification algorithm further comprises classifying users into clusters based on one or more of user types, historical user data, and user feedback, and setting the base frustration level metric and the rate of increase parameter for each user type based on the clusters.

6. The apparatus of claim 3, wherein the conversational artificial intelligence system is further configured to adjust the rate of increase parameter as the conversation progresses based on one or more of: a query type presented by the user; a number of queries presented by the user; an intent derivation status for each query presented by the user; and an active conversation time between the user and the conversational artificial intelligence system.

7. The apparatus of claim 1, wherein managing human agent engagement in the conversation based on the frustration level metric further comprises monitoring where the frustration level metric falls within a set of frustration level ranges, wherein the conversational artificial intelligence system takes different actions based on within which one of the set of frustration level ranges that the frustration level metric falls.

8. The apparatus of claim 7, wherein when the frustration level metric falls within a first frustration level range of the set of frustration level ranges, the conversational artificial intelligence system is further configured to maintain control of the conversation with the user.

9. The apparatus of claim 8, wherein when the frustration level metric falls within a second frustration level range of the set of frustration level ranges, wherein the second frustration level range represents a higher level of user frustration than the first frustration level range, the conversational artificial intelligence system is further configured to send the frustration level metric of the user and additional data to one or more human agents to enable at least one of the one or more human agents to accept monitoring of the conversation and, if so warranted, manually take over the conversation.

10. The apparatus of claim 9, wherein the additional data sent to the one or more live agents comprises a summary context of the conversation generated by the conversational artificial intelligence system comprising data indicative of one or more of: an identity of the user; a type of the user; an intent of the user; a value associated with a subject of a query presented by the user; at least one previous detail of the conversation; and a previous feedback score of the user.

11. The apparatus of claim 9, wherein when the frustration level metric falls within the second frustration level, the conversational artificial intelligence system is further configured to establish a real-time communication channel with at least one of the one or more human agents.

12. The apparatus of claim 11, wherein when the conversational artificial intelligence system is unable to derive an intent for a given query of the user and the frustration level metric falls within the second frustration level, the conversational artificial intelligence system engages in a communication with the at least one human agent to enable at least one human agent to provide assistance to the conversational artificial intelligence system when responding to the given query of the user.

13. The apparatus of claim 9, wherein when the frustration level metric falls within a third frustration level range of the set of frustration level ranges, wherein the third frustration level range represents a higher level of user frustration than the second frustration level range, the conversational artificial intelligence system is further configured to cede control over the conversation to the at least one human agent that previously accepted monitoring of the conversation to enable the at least one human agent to continue the conversation with the user.

14. The apparatus of claim 1, wherein managing human agent engagement in the conversation based on the frustration level metric further comprises generating an interface for presentation to one or more human agents to enable the one or more human agents to monitor the frustration level metric of the user and engage in the conversation as warranted by the frustration level metric.

15. A method comprising:
obtaining, via a conversational artificial intelligence system, a frustration level metric associated with a user participating in a conversation with the conversational artificial intelligence system; and
managing, via the conversational artificial intelligence system, human agent engagement in the conversation based on the frustration level metric.

16. The method of claim 15, wherein obtaining the frustration level metric further comprises:
utilizing a base frustration level metric as the frustration level metric at the start of the conversation; and
utilizing a rate of increase parameter to adjust the base frustration level metric as the conversation progresses and use the adjusted frustration level metric as the frustration level metric.

17. The method of claim 15, wherein managing human agent engagement in the conversation based on the frustration level metric further comprises monitoring where the frustration level metric falls within a set of frustration level ranges, wherein the conversational artificial intelligence system takes different actions based on within which one of the set of frustration level ranges that the frustration level metric falls.

18. The method of claim 15, wherein managing human agent engagement in the conversation based on the frustration level metric further comprises generating an interface for presentation to one or more human agents to enable the one or more human agents to monitor the frustration level metric of the user and engage in the conversation as warranted by the frustration level metric.

19. A computer program product comprising a non-transitory processor-readable storage medium having stored therein program code of one or more software programs, wherein the program code when executed by at least one processing device cause the at least one processing device to operate as a conversational artificial intelligence system configured to:
obtain a frustration level metric associated with a user participating in a conversation with the conversational artificial intelligence system; and
manage human agent engagement in the conversation based on the frustration level metric.

20. The computer program product of claim 19, wherein obtaining the frustration level metric further comprises:
utilizing a base frustration level metric as the frustration level metric at the start of the conversation; and
utilizing a rate of increase parameter to adjust the base frustration level metric as the conversation progresses and use the adjusted frustration level metric as the frustration level metric.
